(19) United States
(12) Patent Application Publication
(10) Pub. No.: US 2013/0141561 A1
(43) Pub. Date: Jun. 6, 2013

(54) METHOD OF ANALYZING LINEARITY OF SHOT IMAGE, IMAGE OBTAINING METHOD, AND IMAGE OBTAINING APPARATUS

(71) Applicant: Sony Corporation, Tokyo (JP)

(72) Inventor: Koichiro Kishima, Kanagawa (JP)

(73) Assignee: SONY CORPORATION, Tokyo (JP)

(21) Appl. No.: 13/686,502

(22) Filed: Nov. 27, 2012

(30) Foreign Application Priority Data
Dec. 6, 2011 (JP) 2011-267224

(51) Int. Cl. G06K 9/78

(52) U.S. Cl. CPC G06K 9/78
USPC 348/79

(57) ABSTRACT

Provided is a method of analyzing a linearity of a shot image, including: irradiating a biological sample having a fluorescent label with an excitation light, the excitation light exciting the fluorescent label, and exposing an image sensor to light while moving a focus position of an optical system including an objective lens in an optical-axis direction and in a direction orthogonal to the optical-axis direction; and analyzing a gamma value for an imaging environment based on a brightness distribution of one bright-point image in a real-shot-image obtained by the image sensor.

### CROSS REFERENCES TO RELATED APPLICATIONS

The present application claims priority to Japanese Priority Patent Application JP 2011-267224 filed in the Japan Patent Office on Dec. 6, 2011, the entire content of which is hereby incorporated by reference.

### BACKGROUND

The present disclosure relates to a method of analyzing a linearity of a shot image, an image obtaining method, and an image obtaining apparatus.

Flow cytometry is known as a method of analyzing and sorting minute particles such as biological tissues. A flow cytometry apparatus (flow cytometer) is capable of obtaining, at high speed, shape information and fluorescence information from each particle such as a cell. The shape information includes size and the like. The fluorescence information is information on DNA/RNA fluorescence stain, and on protein and the like dyed with fluorescence antibody. The flow cytometry apparatus (flow cytometer) is capable of analyzing correlations thereof, and of sorting a target cell group from the particles. Further, imaging cytometry is known as a method of performing cytometry based on a fluorescent image of a cell. In the imaging cytometry, a fluorescent image of a biological sample on a glass slide or a dish is magnified and photographed. Information on each cell in the fluorescent image is digitalized and quantified. The information includes, for example, an intensity (brightness), size, and the like of bright points, which mark a cell with fluorescence. Further, the cell cycle is analyzed, and other processing is performed (see Japanese Patent Application Laid-open No. 2011-107669.).

### SUMMARY

In order to measure an intensity (brightness) of bright points, which are fluorescent labels in an image obtained by a fluorescent microscope, a linearity of brightness of the shot image is important. The linearity of brightness of an image, which is obtained by using an optical system and an image sensor, depends on transfer characteristics of an image sensor and the like. The linearity of brightness of an image does not necessarily match characteristics of a measurement system. In view of this, it is desired to provide a method of analyzing a linearity of brightness of an image, which is obtained by using an optical system and an image sensor. However, such a method has not been proposed yet.

Meanwhile, a method of analyzing a linearity of an image by using fluorescent particles in which intensities of fluorescent bright points are set in a stepwise manner, and other methods are known. However, the fluorescent particles are designed for flow cytometry apparatuses. In general, in a flow cytometry apparatus, an optical system having a relatively large focal depth (focus adjustment is relatively easy) is used. In an optical microscope, an optical system having a relatively small focal depth (focus adjustment is relatively difficult) is used. With such an optical microscope, brightness is decreased when the focus is not adjusted. Because of this, it is difficult to verify a linearity of brightness by using the above-mentioned fluorescent particles.

In view of the above-mentioned circumstances, it is desirable to provide a method of analyzing a linearity of a shot image, an image obtaining method, and an image obtaining apparatus, capable of successfully verifying a linearity of brightness of an image obtained by an optical microscope.

In view of the above-mentioned circumstances, according to an embodiment of the present application, there is provided a method of analyzing a linearity of a shot image, including: irradiating a biological sample having a fluorescent label with an excitation light, the excitation light exciting the fluorescent label, and exposing an image sensor to light while moving a focus position of an optical system including an objective lens in an optical-axis direction and in a direction orthogonal to the optical-axis direction; and analyzing a gamma value for an imaging environment based on a brightness distribution of one bright-point image in a real-shot-image obtained by the image sensor.

According to the present application, the image sensor is exposed to light while moving the focus position in the optical-axis direction and in the direction orthogonal to the optical-axis direction, to thereby obtain a shot image. As a result, a bright-point image having a substantially-ellipsoidal shape may be obtained. A gamma value for the imaging environment may be analyzed based on the brightness distribution of the bright-point image. Linearity of a real-shot-image may be successfully verified.

Analyzing a gamma value for the imaging environment may include comparing a brightness distribution of the real-shot-image with brightness distributions of theoretical bright-point images, the brightness distributions of theoretical bright-point images being obtained by calculation, where a gamma is a variable, under an imaging condition in which an imaging environment of the real-shot-image is simulated except for the image sensor, and analyzing a gamma value for the imaging environment based on a calculated gamma value of a theoretical bright-point image, the theoretical bright-point image having a brightness distribution similar to a brightness distribution of the real-shot-image.

Analyzing a gamma value for the imaging environment may include obtaining an evaluation value V₁ (Value₁) of the shot image by using an expression V₁=(A₁+B₁)/2C₁, where C₁ is indicative of a brightness at a position exhibiting the highest brightness in the one bright-point image, and A₁ and B₁ are indicative of brightness at two points in the one bright-point image, each of the two points being a point obtained by rotating the position by 90°, the position exhibiting the highest brightness in the one bright-point image, the center of the one bright-point image being a rotation center, the two points facing each other via the center of the one bright-point image, obtaining evaluation values V₂ (Value₂) of the theoretical bright-point images by using an expression V₂=(A₂+B₂)/2C₂, where a gamma is a variable, C₂ is indicative of a brightness at a position exhibiting the highest brightness in the theoretical bright-point image, and A₂ and B₂ are indicative of brightness at two points in the theoretical bright-point image, each of the two points being a point obtained by rotating the position by 90°, the position exhibiting the highest brightness in the theoretical bright-point image, the center of the theoretical bright-point image being a rotation center, the two points facing each other via the center of the theoretical bright-point image, comparing the evaluation value V₁ of the shot image with the evaluation values V₂ of the theoretical bright-point images, and analyzing a gamma value for the imaging environment, based on the calculated gamma value where the V₂ similar to the V₁ is obtained.

According to another embodiment of the present application, there is provided an image obtaining method, including: irradiating a biological sample having a fluorescent label with an excitation light, the excitation light exciting the fluorescent label, and exposing an image sensor to light while moving the focus position of an optical system including an objective lens in an optical-axis direction and in a direction orthogonal to the optical-axis direction; obtaining a gamma value for an imaging environment based on a brightness distribution of one bright-point image in a real-shot-image obtained by the image sensor; and correcting an electric signal output from the image sensor by using the obtained gamma value to thereby generate a shot image.

According to another embodiment of the present application, there is provided an image obtaining apparatus, including: a light source configured to irradiate a biological sample having a fluorescent label with an excitation light, the excitation light exciting the fluorescent label; an optical system including an objective lens, the objective lens being configured to magnify an imaging target of the biological sample; an image sensor configured to form an image of the imaging target magnified by the objective lens; a movement controller configured to move a focus position of the optical system; a light-exposure controller configured to expose the image sensor to light while moving the focus position of the optical system in an optical-axis direction and in a direction orthogonal to the optical-axis direction; a calculation unit configured to calculate a gamma value for an imaging environment based on a brightness distribution of one bright-point image in a real-shot-image obtained by the image sensor; and a correction unit configured to correct an electric signal output from the image sensor by using the gamma value for the imaging environment, the gamma value being calculated by the calculation unit.

As described above, according to this technology, a linearity of brightness of a shot image may be successfully verified.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing an image obtaining apparatus according to an embodiment of the present application;

FIG. 2 is a diagram showing a biological sample as a target, whose image is to be obtained by the image obtaining apparatus of FIG. 1;

FIG. 3 is a block diagram showing a hardware configuration of a data processing unit of the image obtaining apparatus of FIG. 1;

FIG. 4 is a functional block diagram showing a process of obtaining a biological sample image by the image obtaining apparatus of FIG. 1;

FIG. 5 is a diagram showing imaging target areas imaged by the image obtaining apparatus of FIG. 1;

FIG. 6 is a diagram showing temporal changes of shapes and positions of images obtained by the image sensor, in which the shapes and positions of images change because the image obtaining apparatus of FIG. 1 moves the focus position during the light-exposure;

FIG. 7 is a diagram showing one bright-point image in a real-shot-image and a theoretical bright-point image, and showing positions corresponding to brightness values A, B, and C, which are substituted in an expression for obtaining an image evaluation value based on a brightness distribution of an image;

FIG. 8A shows one bright-point image in a real-shot-image, and FIGS. 8B to 8J show theoretical bright-point images obtained by calculation, where gamma values are 0.5, 0.75, 1.0, 1.25, 1.5, 1.75, 2.0, 2.2, and 2.5, respectively;

FIG. 9 is a diagram showing a theoretical-bright-point-image evaluation-value table, the table showing the relation between gamma values of the theoretical bright-point images of FIGS. 8B to 8J and brightness-evaluation values V₂; and

FIG. 10 is a diagram showing a graph showing the theoretical-bright-point-image evaluation-value table of FIG. 9.

### DETAILED DESCRIPTION

Hereinafter, an embodiment of the present disclosure will be described with reference to the drawings.

[Outline of this Embodiment]

This embodiment relates to an image obtaining method including analyzing a linearity of a real-shot-image obtained by an optical microscope, and correcting the real-shot-image based on an analysis result.

In order to measure an intensity (brightness) of bright points, which are fluorescent labels in an image obtained by a fluorescent microscope, a linearity of brightness of the shot image is important. For example, the following is one method of analyzing a linearity of brightness of a shot image. That is, a plurality of real-shot-images are obtained while changing a gamma value. An analyst compares the plurality of real-shot-images with a result of observing a biological sample with the eyes by using an optical system. The analyst analyzes a linearity of brightness of a shot image. However, this analysis method takes time to perform analysis because it needs a plurality of shot images. In addition, it is difficult to analyze slight differences with the eyes.

To solve such problems, according to the image obtaining method of this embodiment, a gamma value for an imaging environment is obtained based on a brightness distribution of one bright-point image in one real-shot-image obtained by using an optical system and an image sensor. The imaging environment includes characteristics of an image sensor, an ambient temperature during image-shooting, and the like.

Specifically, an optical system and an image sensor are used. The image sensor is exposed to light while moving the focus position of the optical system in an optical-axis direction and in a direction orthogonal to the optical-axis direction, to thereby obtain a real-shot-image. A brightness-evaluation value is obtained based on a brightness distribution of the real-shot-image. Further, in addition to the brightness-evaluation value of the real-shot-image, brightness-evaluation values are previously obtained based on brightness distributions of theoretical bright-point images. The theoretical bright-point images are obtained by calculation, where a gamma is a variable, under an imaging condition in which an imaging environment of the real-shot-image is simulated except for an image sensor. Then, the brightness-evaluation value of one bright-point image of one real-shot-image is compared with the brightness-evaluation values of a plurality of theoretical bright-point images, which are previously obtained by using different gamma values. As a result, a linearity of brightness of a real-shot-image may be successfully verified.

Further, a gamma value for an imaging environment is obtained based on a calculated gamma value of a theoretical bright-point image, which has a brightness-evaluation value similar to the brightness-evaluation value of one bright-point image in a real-shot-image. By using the obtained gamma value for the imaging environment, a real-shot-image, which is obtained by using an optical system and an image sensor, is corrected. The corrected shot image reproduces the intensity of bright points, which are fluorescent labels on a biological sample as an imaging target, more accurately. After all, the corrected shot image has a linearity. Because of this, brightness of a bright-point image in a shot image may be quantified and analyzed.

Hereinafter, an embodiment of the present disclosure will be described with reference to the drawings.

[Structure of Image Obtaining Apparatus]

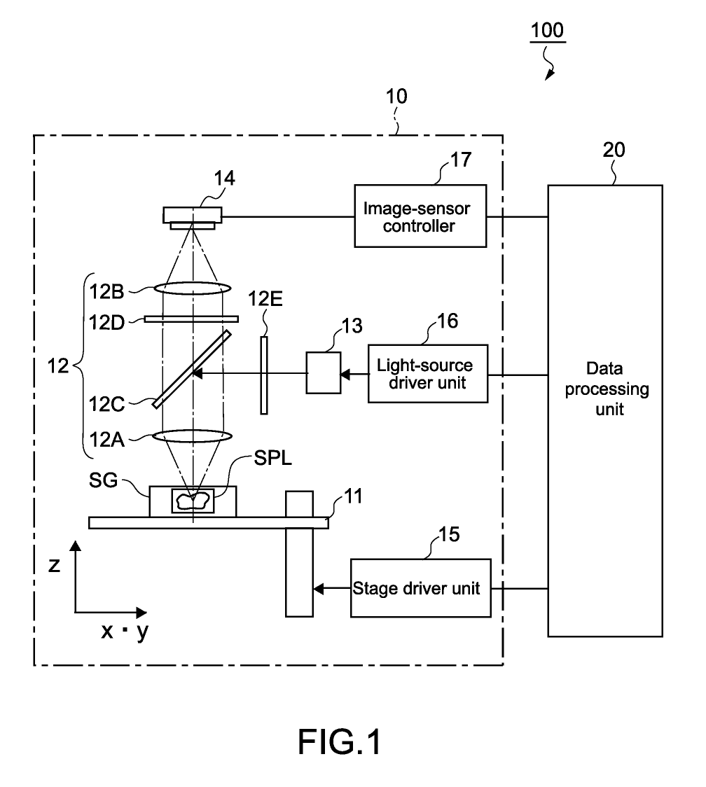

FIG. 1 is a schematic diagram showing an image obtaining apparatus 100 according to an embodiment. As shown in FIG. 1, the image obtaining apparatus 100 of this embodiment includes a microscope 10 and a data processing unit 20.

[Structure of Microscope 10]

The microscope 10 includes a stage 11, an optical system 12, a light source 13, and an image sensor 14.

The stage 11 has a mount surface. A biological sample SPL is mounted on the mount surface. Examples of the biological sample SPL include a slice of tissue, a cell, a biopolymer such as a chromosome, and the like. The stage 11 is capable of moving in the horizontal direction (x-y plane direction) and in the vertical direction (z-axis direction) with respect to the mount surface.

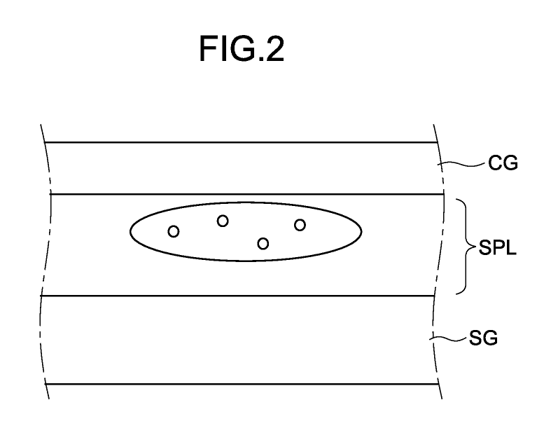

FIG. 2 is a diagram showing the biological sample SPL mounted on the above-mentioned stage 11. FIG. 2 shows the biological sample SPL in the direction from the side of the stage 11. As shown in FIG. 2, the biological sample SPL has a thickness of several μm to several tens of μm in the Z direction, for example. The biological sample SPL is sandwiched between a slide glass SG and a cover glass CG, and is fixed by a predetermined fixing method. The biological sample SPL is dyed with a fluorescence staining reagent. Fluorescence staining reagent is a stain irradiated with an excitation light from the same light source to thereby emit fluorescence. As the fluorescence staining reagent, for example, DAPI(4′,6-diamidino-2-phenylindole), SpAqua, SpGreen, or the like may be used.

With reference to FIG. 1 again, the optical system 12 is arranged above the stage 11. The optical system 12 includes an objective lens 12A, an imaging lens 12B, a dichroic mirror 12C, an emission filter 12D, and an excitation filter 12E. The light source 13 is, for example, a light bulb such as a mercury lamp, an LED (Light Emitting Diode), or the like. Fluorescent labels in a biological sample are irradiated with an excitation light from the light source 13.

In a case of obtaining a fluorescent image of the biological sample SPL, the excitation filter 12E only causes light, which has an excitation wavelength for exciting fluorescent dye, to pass through, out of light emitted from the light source 13, to thereby generate an excitation light. The excitation light, which has passed through the excitation filter and enters the dichroic mirror 12C, is reflected by the dichroic mirror 12C, and is guided to the objective lens 12A. The objective lens 12A condenses the excitation light on the biological sample SPL. Then, the objective lens 12A and the imaging lens 12B magnify the image of the biological sample SPL at a predetermined power, and form the magnified image in an imaging area of the image sensor 14.

When the biological sample SPL is irradiated with the excitation light, the stain emits fluorescence. The stain is bound to each tissue of the biological sample SPL. The fluorescence passes through the dichroic mirror 12C via the objective lens 12A, and reaches the imaging lens 12B via the emission filter 12D. The emission filter 12D absorbs light (outside light) other than color light, which is magnified by the above-mentioned objective lens 12A. As described above, the imaging lens 12B magnifies an image of the color light, from which outside light is lost. The imaging lens 12B forms an image on the image sensor 14.

As the image sensor 14, for example, a CCD (Charge Coupled Device), a CMOS (Complementary Metal Oxide Semiconductor) image sensor, or the like is used. The image sensor 14 has a photoelectric conversion element, which receives RGB (Red, Green, Blue) colors separately and converts the colors into electric signals. The image sensor 14 is a color imager, which obtains a color image based on incident light.

The light-source driver unit 16 drives the light source 13 based on instructions from a light source controller 36 (described later) of the data processing unit 20. The stage driver unit 15 drives the stage 11 based on instructions from a stage controller 31 (described later) of the data processing unit 20. The image-sensor controller 17 controls to expose the image sensor 14 to light based on instructions from an image obtaining unit 32 (described later) of the data processing unit 20. The image-sensor controller 17 obtains images from the image sensor 14. The image-sensor controller 17 provides the images to the image obtaining unit 32.

[Configuration of Data Processing Unit 20]

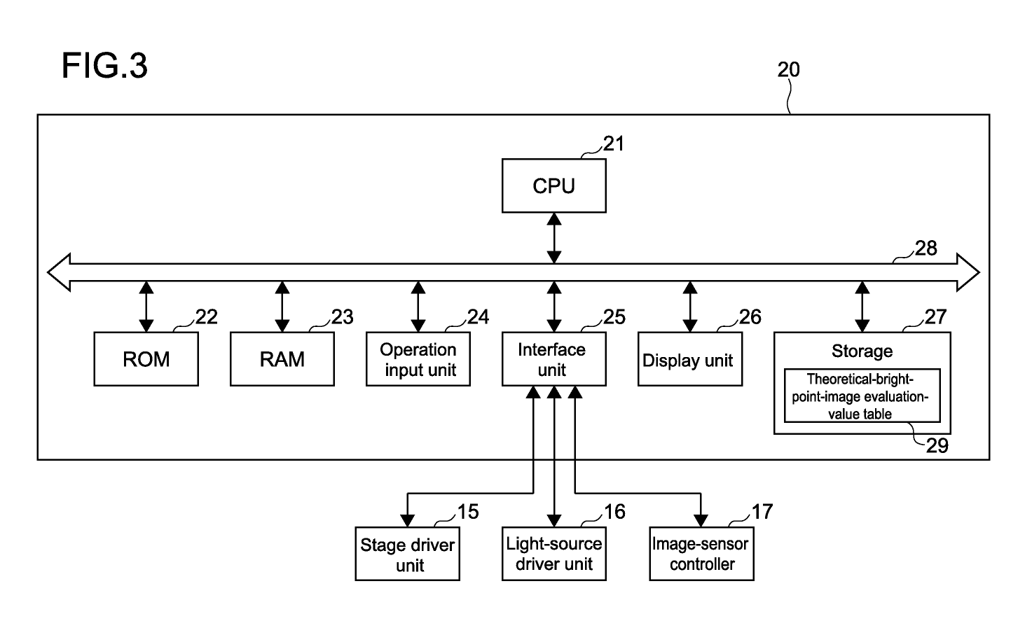

FIG. 3 is a block diagram showing the hardware configuration of the data processing unit 20.

The data processing unit 20 is configured by, for example, a PC (Personal Computer). The data processing unit 20 stores a fluorescent image (real-shot-image) of the biological sample SPL, which is obtained from the image sensor 14, as digital image data of an arbitrary-format such as JPEG (Joint Photographic Experts Group), for example.

As shown in FIG. 3, the data processing unit 20 includes a CPU (Central Processing Unit) 21, a ROM (Read Only Memory) 22, a RAM (Random Access Memory) 23, an operation input unit 24, an interface unit 25, a display unit 26, and storage 27. Those blocks are connected to each other via a bus 28.

The ROM 22 is fixed storage for storing data and a plurality of programs such as firmware executing various processing. The RAM 23 is used as a work area of the CPU 21, and temporarily stores an OS (Operating System), various applications being executed, and various data being processed.

The storage 27 is a nonvolatile memory such as an HDD (Hard Disk Drive), a flash memory, or another solid memory, for example. The OS, various applications, and various data are stored in the storage 27. Specifically, in this embodiment, fluorescent image (real-shot-image) data captured by the image sensor 14, and an image correction application for processing fluorescent image (real-shot-image) data are stored in the storage 27. Further, a theoretical-bright-point-image evaluation-value table 29 (described later), and corrected image data (described later) are stored in the storage 27.

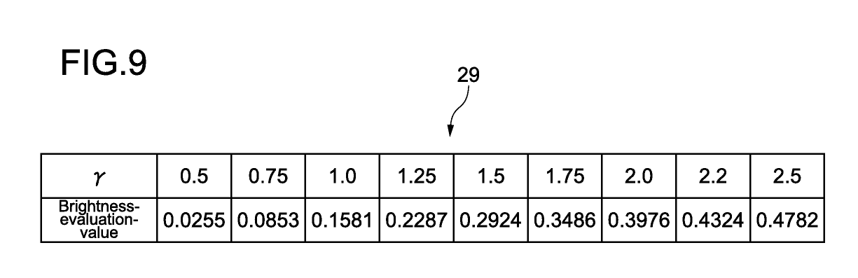

FIG. 9 shows the theoretical-bright-point-image evaluation-value table 29.

As shown in FIG. 9, in the theoretical-bright-point-image evaluation-value table 29, calculated theoretical-bright-point-image brightness-evaluation-values are register for each gamma (γ) value. Here, the theoretical-bright-point-images are images obtained by calculation, where the gamma is a variable, under the imaging condition in which the imaging environment of a real-shot-image is simulated except for an image sensor. How to obtain a brightness-evaluation value will be described later.

With reference to FIG. 3 again, the interface unit 25 is connected to a control board including a stage driver unit 15, a light-source driver unit 16, and an image-sensor controller 17. The stage driver unit 15 drives the stage 11 of the microscope 10. The light-source driver unit 16 drives the light source 13 of the microscope 10. The image-sensor controller 17 drives the image sensor 14 of the microscope 10. The interface unit 25 sends and receives signals to and from the control board and the data processing unit 20 according to a predetermined communication standard.

The CPU 21 expands, in the RAM 23, programs corresponding to instructions received from the operation input unit 24 out of a plurality of programs stored in the ROM 22 or in the storage 27. The CPU 21 arbitrarily controls the display unit 26 and the storage 27 according to the expanded programs. The CPU 21 obtains a living-body-sample image based on a program (image obtaining program) expanded in the RAM 23.

The operation input unit 24 is an operating device such as a pointing device (for example, mouse), a keyboard, or a touch panel.

The display unit 26 is a liquid crystal display, an EL (Electro-Luminescence) display, a plasma display, a CRT (Cathode Ray Tube) display, or the like, for example. The display unit 26 may be built in the data processing unit 20, or may be externally connected to the data processing unit 20.

[Functional Configuration of Data Processing Unit 20]

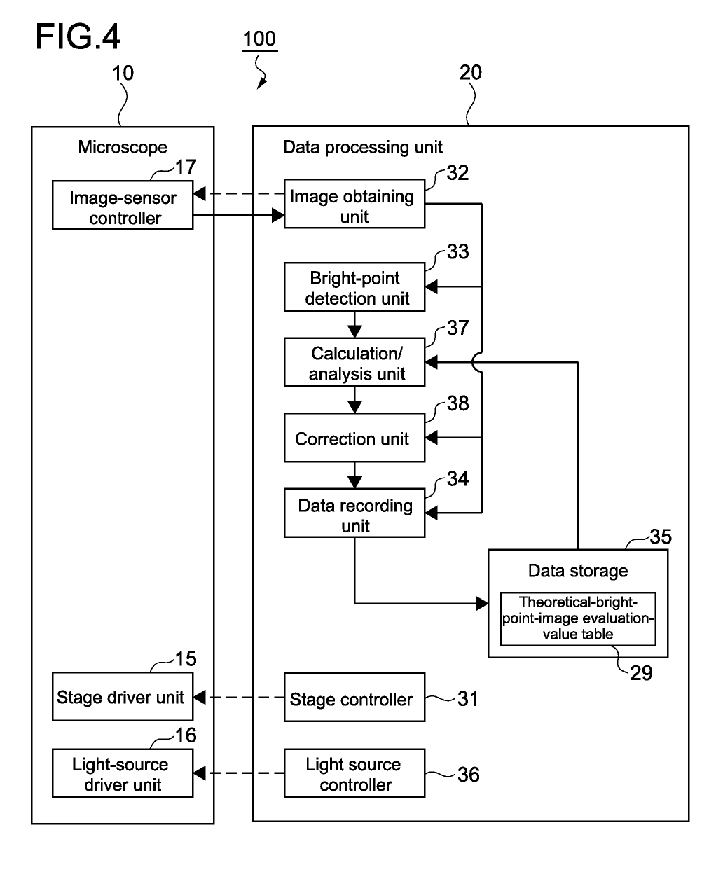

FIG. 4 is a functional block diagram for explaining a process of obtaining a living-body-sample image by the image obtaining apparatus 100.

As shown in FIG. 4, the data processing unit 20 includes an image obtaining unit 32, a bright-point detection unit 33, a calculation/analysis unit 37, a correction unit 38, a data recording unit 34, data storage 35, a stage controller 31, and a light source controller 36.

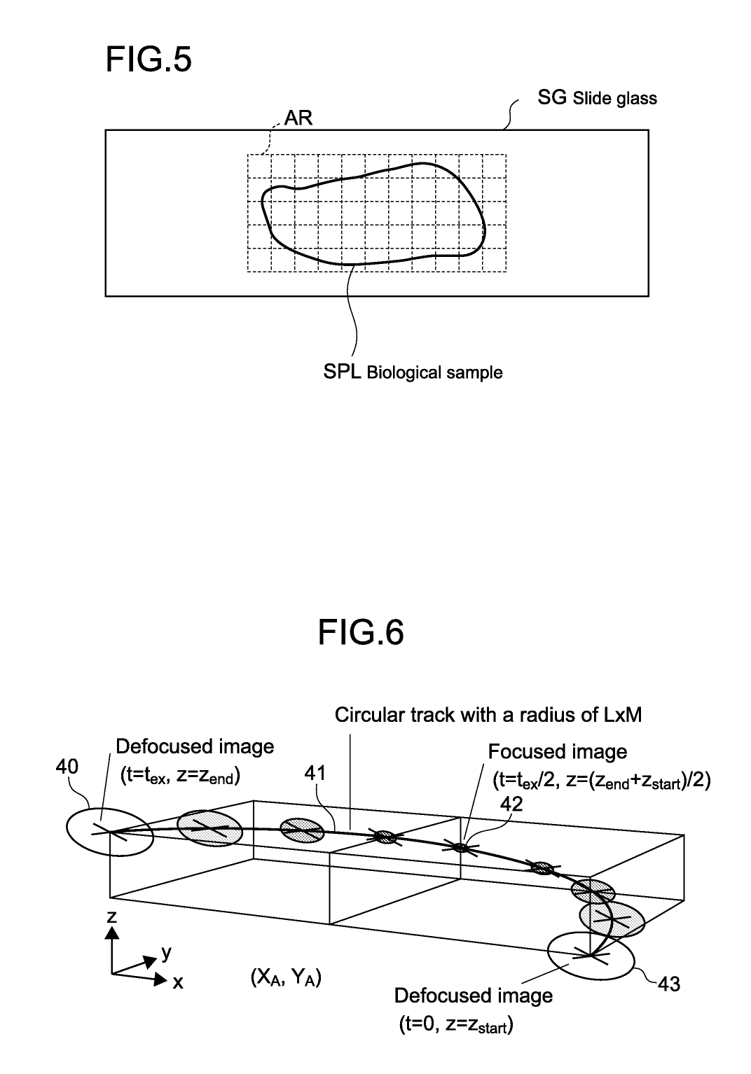

In FIG. 4, the stage controller 31 (movement controller) sends instructions to the stage driver unit 15. Receiving the instructions, the stage driver unit 15 sequentially moves the stage 11 such that a target site of a biological sample SPL (hereinafter, referred to as “sample site”) is in an imaged area. For example, as shown in FIG. 5, the biological sample SPL is allocated to the imaged areas AR.

Further, every time a target sample site is moved to each imaged area AR, the stage controller 31 controls the stage 11 to move in the z-axis direction (optical axis direction of objective lens 12A) to thereby move the focus on the sample site in the thickness direction. At the same time, the stage controller 31 controls the stage 11 to move on the xy plane (plane orthogonal to optical-axis direction of objective lens 12A). The stage controller 31 moves the stage 11 during light-exposure.

FIG. 6 is a diagram showing temporal changes of shapes and positions of images obtained by the image sensor 14. The shapes and positions of images change because the stage 11 moves the focus position during the light-exposure to thereby change the focus position. The track 41 shows how the position of the image changes.

As shown in FIG. 6, the stage controller 31 moves the stage 11 in the descending manner (in FIG. 6) in the z-axis direction at a constant velocity. At the same time, the stage controller 31 circularly moves the stage 11 on the xy plane at the constant velocity. At the time point when light-exposure is started, the focus of the objective lens is not adjusted on a fluorescent marker combined with a specific gene. Then, the focus is adjusted on a fluorescent marker. Then, at the time point when the light-exposure is finished, the focus is not adjusted on a fluorescent marker again.

Specifically, at the light-exposure start position, the image sensor 14 obtains a color-light image (defocused image) 40, which is a blurred circular image emitted from a fluorescent marker.

Then, as the light-exposure time passes, the focus is being gradually adjusted. The image sensor 14 obtains a focused image 41 when the z-axis coordinate of the image is (z_{end}+zₛₜₐᵣₜ)/2 and the light-exposure time is tₑₓ/2, where zₛₜₐᵣₜ is indicative of the z-axis coordinate of the image at the light-exposure start position, z_{end} is indicative of the z-axis coordinate of the image at the light-exposure end position, and tₑₓ is indicative of the light-exposure time.

Further, as the light-exposure time passes, the image is defocused again. At the light-exposure end position, the image sensor 14 obtains a color-light image (defocused image) 43, which is a blurred circular image emitted from a fluorescent marker.

With reference to FIG. 4 again, the data storage 35 stores fluorescent-image data captured by the image sensor 14, an image-correction application for processing fluorescent-image data, and the theoretical-bright-point-image evaluation-value table 29. The calculation/analysis unit 37 (described later) previously generates the theoretical-bright-point-image evaluation-value table 29.

FIG. 9 shows the theoretical-bright-point-image evaluation-value table 29.

As shown in FIG. 9, in the theoretical-bright-point-image evaluation-value table 29, calculated theoretical-bright-point-image brightness-evaluation-values are register for each gamma (γ) value.

With reference to FIG. 4 again, the image obtaining unit 32 (light-exposure controller) sends an instruction to the image-sensor controller 17 every time the stage controller 31 moves the target sample site to the imaged area AR. The instruction is to expose the image sensor 14 to light from the initial time point of movement of the stage 11 in the Z-axis direction and on the xy plane to the final time point. At the final time point of the movement of the stage 11 in the Z-axis direction and on the xy plane, the image obtaining unit 32 obtains images from the image sensor 14 via the image-sensor controller 17. The images are images of the sample sites obtained by light-exposure between the final time point of the movement and the initial time point of the movement. Then, the image obtaining unit 32 combines the images of the sample sites allocated to the imaged areas AR by using a predetermined combining algorithm, respectively, to thereby generate an entire biological sample image (real-shot-image).

The bright-point detection unit 33 detects bright points emitting fluorescence from the biological sample image (real-shot-image) generated by the image obtaining unit 32.

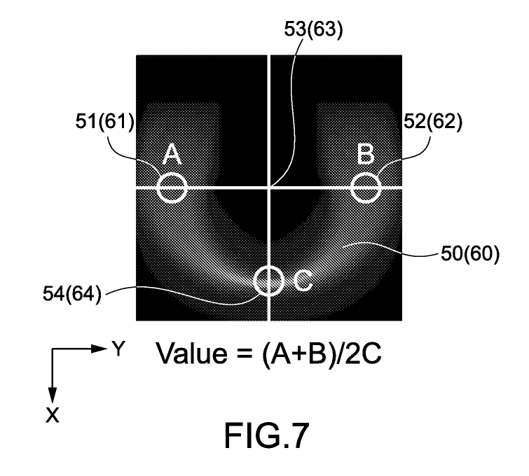

Here, the living-body-sample image is obtained by exposing the image sensor 14 to light while moving the focus position in the thickness direction of the biological sample SPL and in the direction orthogonal to the thickness direction of the biological sample SPL. Because of this, in the living-body-sample image, each fluorescent marker is marked as a blurred bright-point image having a circular shape or an arc shape as shown in FIG. 7.

The calculation/analysis unit 37 generates the theoretical-bright-point-image evaluation-value table 29, and stores it in the data storage 35. Further, the calculation/analysis unit 37 calculates a brightness-evaluation value of a real-shot-image. The calculation/analysis unit 37 compares the brightness-evaluation value of a real-shot-image with the brightness-evaluation values of theoretical bright-point images, and analyzes the brightness-evaluation values.

First, how to generate the theoretical-bright-point-image evaluation-value table 29 will be described.

The calculation/analysis unit 37 previously obtains theoretical bright-point images by calculation, where the gamma is a variable, under the imaging condition in which the imaging environment of a real-shot-image is simulated except for the image sensor 14. Further, the calculation/analysis unit 37 calculates brightness-evaluation values V₂ based on brightness distributions of the theoretical bright-point images obtained by calculation, by using a calculation method (described later). The calculation/analysis unit 37 generates the theoretical-bright-point-image evaluation-value table 29 (see FIG. 9), in which gamma values and brightness-evaluation values are registered.

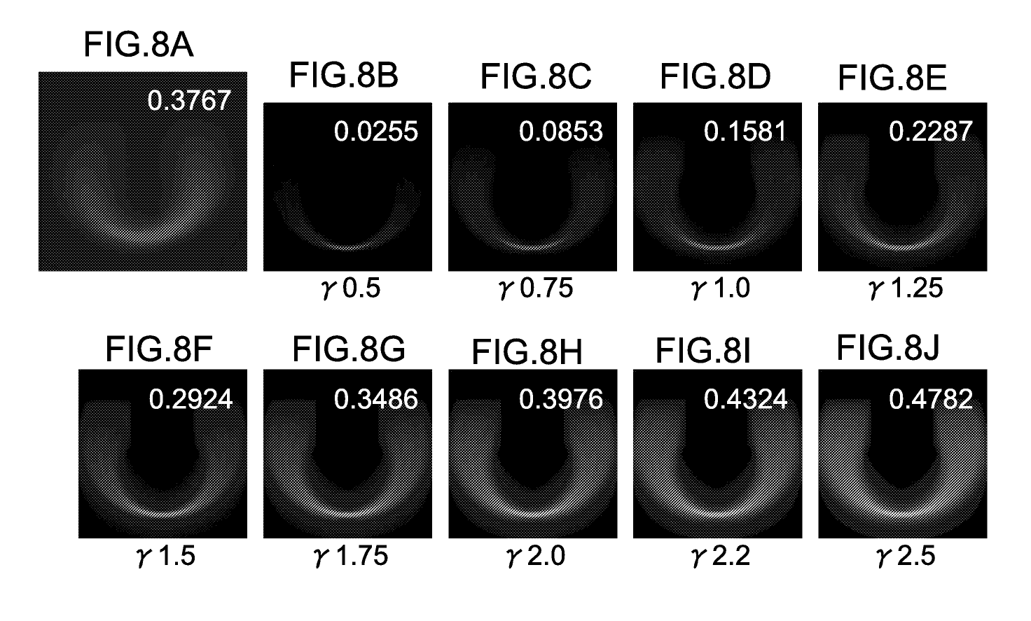

FIGS. 8B to 8J show calculated theoretical bright-point images where the gamma values are 0.5, 0.75, 1.0, 1.25, 1.5, 1.75, 2.0, 2.2, and 2.5, respectively. In each of FIGS. 8B to 8J, a numerical value shown at the top of the image is a brightness-evaluation value obtained by a calculation method (described later). As shown in FIGS. 8B to 8J, by changing the gamma value, the arc shape of the theoretical bright-point image is changed.

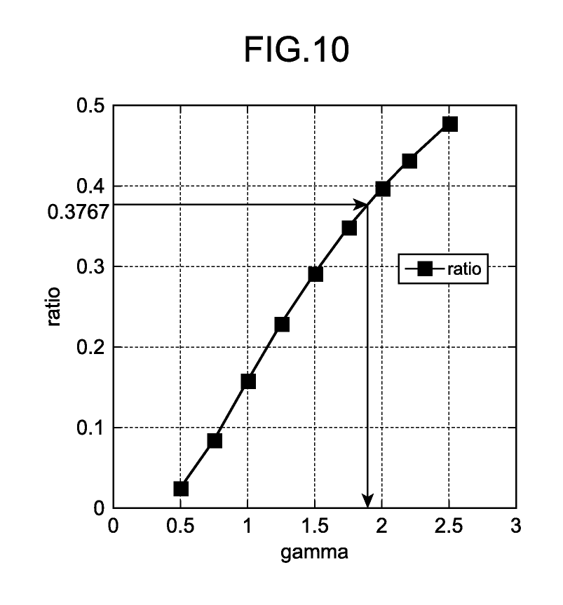

FIG. 9 is a diagram showing the theoretical-bright-point-image evaluation-value table 29, the table showing the relation between the gamma values of the theoretical bright-point images of FIGS. 8B to 8J and the brightness-evaluation values V₂. FIG. 10 is a graph showing the theoretical-bright-point-image evaluation-value table 29 of FIG. 9, in which the horizontal axis shows gamma values and the vertical axis shows brightness-evaluation values. As shown in FIG. 10, an approximately-linear-function relation is established between the gamma values and the brightness-evaluation values.

Next, how to obtain a brightness-evaluation value of a real-shot-image will be described.

The calculation/analysis unit 37 obtains a brightness-evaluation value V₁ from the brightness distribution of one and only bright-point image or one bright-point image out of a plurality of bright-point images in a real-shot-image by using a calculation method (described later). FIG. 8A shows an example of the shape of one bright-point image in a real-shot-image. The numerical value shown at the top of the image is a brightness-evaluation value V₁, which is obtained by a calculation method (described later).

The brightness-evaluation value V₁ of a bright-point image in a real-shot-image is obtained as follows, for example. The brightness-evaluation value V₂ of a theoretical bright-point image is obtained as follows, for example.

FIG. 7 shows an example of one bright-point image in a real-shot-image (theoretical bright-point image).

As shown in FIG. 7, the bright-point image 50 of a real-shot-image (theoretical bright-point image 60) has an arc shape. Hereinafter, the bright-point image 50 of a real-shot-image is simply referred to as the bright-point image 50.

A position 54 (64) exhibits brightness C₁ (C₂), which is the highest brightness in the bright-point image 50 (theoretical bright-point image 60). Two points 51 (61) and 52 (62) in the bright-point image 50 (theoretical bright-point image 60) exhibit brightness A₁ (A₂) and B₁ (B₂), respectively. Each of the two points 51 (61) and 52 (62) is a point obtained by rotating the position 54 (64), which exhibits the highest brightness in the bright-point image 50 (theoretical bright-point image 60), by 90° while the center 53 (63) of the bright-point image 50 (theoretical bright-point image 60) is the rotation center. The point 51 (61) faces the point 52 (62) via the center 53 (63) of the bright-point image 50 (theoretical bright-point image 60). The brightness-evaluation value V₁ (Value₁) (V₂ (Value₂)) of the bright-point image 50 (theoretical bright-point image 60) is obtained by the expression:

V₁=(A₁+B₁)/2C₁(V₂=(A₂+B₂)/2C₂).

Next, comparison and analysis of a brightness-evaluation value V₁ of a real-shot-image and brightness-evaluation values V₂ of theoretical bright-point images will be described.

The calculation/analysis unit 37 compares the brightness-evaluation value V₁ of the bright-point image 50 with the brightness-evaluation values V₂ of the theoretical bright-point images 60. The calculation/analysis unit 37 analyzes a gamma value for the imaging environment, based on a calculated gamma value when the brightness-evaluation value V₂ of the theoretical bright-point image 60, which is similar to the brightness-evaluation value V₁ of the bright-point image 50, is obtained.

For example, the brightness-evaluation value V₁ of the bright-point image 50 of a real-shot-image is 0.3767. In this case, as shown in FIG. 8 and FIG. 9, the brightness-evaluation value V₁ is between the brightness-evaluation value V₂=0.3486, where the gamma value of the theoretical bright-point image 60 is 1.75, and the brightness-evaluation value V₂=0.3976, where the gamma value is 2.0. The calculation/analysis unit 37 determines that the gamma value for the imaging environment is similar to 2.0, and further determines that the gamma value is between 1.75 and 2.0.

As described above, an approximately-linear-function relation is established between the gamma values and the brightness-evaluation values. In view of this, the calculation/analysis unit 37 obtains, based on the brightness-evaluation value V₂, where the gamma value is 1.75, and a brightness-evaluation value V₂, where a gamma value is 2.0, the linear-function expression:

y=0.196x+0.0056

where x is indicative of a gamma value, and y is indicative of a brightness-evaluation value. The linear-function expression expresses the relation between the gamma values and the brightness-evaluation values. Then, the calculation/analysis unit 37 calculates the gamma value (about 1.89) for the imaging environment, based on the linear-function expression and the brightness-evaluation value V₁ (0.3767) of the bright-point image 50 of a real-shot-image.

By using the gamma value for the imaging environment calculated by the calculation/analysis unit 37, the correction unit 38 corrects an electric signal output from the image sensor. As a result, the correction unit 38 corrects living-body-sample images of sample sites, which are obtained by the image obtaining unit 32, for each sample site, to thereby generate corrected images.

The data recording unit 34 combines biological sample images of each sample site, which are corrected by the correction unit 38, to thereby generate one biological sample image. The data recording unit 34 encodes the one biological sample image to thereby obtain sample data of the predetermined compression format such as JPEG (Joint Photographic Experts Group), and records the sample data in data storage 35.

The light source controller 36 controls timing of emitting light from the light source 13. The light source controller 36 sends an instruction to emit or not to emit light from the light source 13, to the light-source driver unit 16.

[Method of Obtaining Living-Body-Sample Image (Image Obtaining Method)]

Next, a method of obtaining a living-body-sample image by using the above-mentioned image obtaining apparatus 100 will be described.

First, the calculation/analysis unit 37 previously obtains theoretical bright-point images 60 by calculation, where the gamma is a variable, under the imaging condition in which the imaging environment of a real-shot-image is simulated except for an image sensor. The calculation/analysis unit 37 calculates the brightness-evaluation values V₂ based on the brightness distributions of the theoretical bright-point images 60 by using the above-mentioned calculation method. The calculation/analysis unit 37 previously generates the theoretical-bright-point-image evaluation-value table 29 (see FIG. 9). The calculation/analysis unit 37 stores the generated theoretical-bright-point-image evaluation-value table 29 in the data storage 35.

The image obtaining unit 32 irradiates a biological sample SPL with an excitation light. The biological sample SPL is mounted on the stage, and is marked with fluorescence. The image obtaining unit 32 exposes the image sensor 14 to color-light images emitted from fluorescent markers. The image obtaining unit 32 obtains a real-shot-image of a sample site obtained by light-exposure from the image sensor 14 via the image-sensor controller 17. During light-exposure, the stage controller 31 moves the stage 11 in the z-axis direction (optical-axis direction of objective lens 12A) and on the xy plane simultaneously.

Next, the bright-point detection unit 33 detects bright points, which emit fluorescence, from a living-body-sample image (real-shot-image) generated by the image obtaining unit 32. The calculation/analysis unit 37 calculates the brightness-evaluation value V₁ from the brightness distribution of the detected bright-point image 50 by using the above-mentioned calculation method.

Next, the calculation/analysis unit 37 compares the brightness-evaluation value V₁ of the bright-point image 50 with the brightness-evaluation values V₂ of the theoretical bright-point images 60 stored in the data storage 35. The calculation/analysis unit 37 calculates a gamma value for the imaging environment based on a calculated gamma value when the brightness-evaluation value V₂ of the theoretical bright-point image 60, which is similar to the brightness-evaluation value V₁ of the bright-point image 50, is obtained. The gamma value for the imaging environment is calculated as described above.

Next, by using the gamma value for the imaging environment calculated by the calculation/analysis unit 37, the correction unit 38 corrects living-body-sample images of sample sites, which are obtained by the image obtaining unit 32, for each sample site, to thereby generate corrected images.

The data recording unit 34 combines biological sample images of each sample site, which are corrected by the correction unit 38, to thereby generate one biological sample image. The data recording unit 34 encodes the one biological sample image to thereby obtain sample data of the predetermined compression format such as JPEG (Joint Photographic Experts Group), and records the sample data in data storage 35.

As described above, according to the configuration of this embodiment, the brightness-evaluation value of one bright-point image in one real-shot-image is compared with the previously-obtained brightness-evaluation values of a plurality of theoretical bright-point images, which use gamma values different from each other. As a result, a linearity of brightness of a real-shot-image is successfully verified.

Further, in this embodiment, a gamma value for the imaging environment is obtained based on a calculated gamma value of a theoretical bright-point image, which has a brightness-evaluation value similar to the brightness-evaluation value of one bright-point image in a real-shot-image. By using the obtained gamma value for the imaging environment, the real-shot-image, which is obtained by using an optical system and an image sensor, is corrected. The corrected image is an image in which the intensity of bright points, which are obtained by marking a biological sample as an imaging target with fluorescence, is reproduced more accurately. As a result, the corrected image has a linearity. Because of this, the brightness of bright-point images in a shot image may be quantified and analyzed.

Further, in the above-mentioned embodiment, the stage 11 is moved to thereby move the focus position. Alternatively, the objective lens 12A of the optical system 12 may be moved.

Note that the present application may employ the following configurations.

(1) A method of analyzing a linearity of a shot image, comprising:

irradiating a biological sample having a fluorescent label with an excitation light, the excitation light exciting the fluorescent label, and exposing an image sensor to light while moving a focus position of an optical system including an objective lens in an optical-axis direction and in a direction orthogonal to the optical-axis direction; and

analyzing a gamma value for an imaging environment based on a brightness distribution of one bright-point image in a real-shot-image obtained by the image sensor.

(2) The method of analyzing a linearity of a shot image according to (1), wherein analyzing a gamma value for the imaging environment includes

comparing a brightness distribution of the real-shot-image with brightness distributions of theoretical bright-point images, the brightness distributions of theoretical bright-point images being obtained by calculation, where a gamma is a variable, under an imaging condition in which an imaging environment of the real-shot-image is simulated except for the image sensor, and

analyzing a gamma value for the imaging environment based on a calculated gamma value of a theoretical bright-point image, the theoretical bright-point image having a brightness distribution similar to a brightness distribution of the real-shot-image.

(3) The method of analyzing a linearity of a shot image according to (2), wherein analyzing a gamma value for the imaging environment includes

obtaining an evaluation value V₁ (Value₁) of the shot image by using an expression V₁=(A₁+B₁)2C₁, where
C₁ is indicative of a brightness at a position exhibiting the highest brightness in the one bright-point image, and
A₁ and B₁ are indicative of brightness at two points in the one bright-point image, each of the two points being a point obtained by rotating the position by 90°, the position exhibiting the highest brightness in the one bright-point image, the center of the one bright-point image being a rotation center, the two points facing each other via the center of the one bright-point image,

obtaining evaluation values V₂ (Value₂) of the theoretical bright-point images by using an expression V₂=(A₂+B₂)/2C₂, where
a gamma is a variable,
C₂ is indicative of a brightness at a position exhibiting the highest brightness in the theoretical bright-point image, and
A₂ and B₂ are indicative of brightness at two points in the theoretical bright-point image, each of the two points being a point obtained by rotating the position by 90°, the position exhibiting the highest brightness in the theoretical bright-point image, the center of the theoretical bright-point image being a rotation center, the two points facing each other via the center of the theoretical bright-point image,
comparing the evaluation value V₁ of the shot image with the evaluation values V₂ of the theoretical bright-point images, and
analyzing a gamma value for the imaging environment, based on the calculated gamma value where the V₂ similar to the V₁ is obtained.
   (4) An image obtaining method, comprising:

irradiating a biological sample having a fluorescent label with an excitation light, the excitation light exciting the fluorescent label, and exposing an image sensor to light while moving the focus position of an optical system including an objective lens in an optical-axis direction and in a direction orthogonal to the optical-axis direction;

obtaining a gamma value for an imaging environment based on a brightness distribution of one bright-point image in a real-shot-image obtained by the image sensor; and

correcting an electric signal output from the image sensor by using the obtained gamma value to thereby generate a shot image.

(5) The image obtaining method according to (4), further comprising:

comparing a brightness distribution of the real-shot-image with brightness distributions of theoretical bright-point images, the brightness distributions of theoretical bright-point images being obtained by calculation, where a gamma is a variable, under an imaging condition in which an imaging environment of the real-shot-image is simulated except for the image sensor; and

obtaining a gamma value for the imaging environment based on a calculated gamma value of a theoretical bright-point image, the theoretical bright-point image having a brightness distribution similar to a brightness distribution of the real-shot-image.

(6) The image obtaining method according to (5), further comprising:

obtaining an evaluation value V₁ (Value₁) of the shot image by using an expression V₁=(A₁+B₁)/2C₁, where
C₁ is indicative of a brightness at a position exhibiting the highest brightness in the one bright-point image, and
A₁ and B₁ are indicative of brightness at two points in the one bright-point image, each of the two points being a point obtained by rotating the position by 90°, the position exhibiting the highest brightness in the one bright-point image, the center of the one bright-point image being a rotation center, the two points facing each other via the center of the one bright-point image;

obtaining evaluation values V₂ (Value₂) of the theoretical bright-point images by using an expression V₂=(A₂+B₂)/2C₂, where
a gamma is a variable,
C₂ is indicative of a brightness at a position exhibiting the highest brightness in the theoretical bright-point image, and
A₂ and B₂ are indicative of brightness at two points in the theoretical bright-point image, each of the two points being a point obtained by rotating the position by 90°, the position exhibiting the highest brightness in the theoretical bright-point image, the center of the theoretical bright-point image being a rotation center, the two points facing each other via the center of the theoretical bright-point image;

comparing the evaluation value V₁ of the shot image with the evaluation values V₂ of the theoretical bright-point images; and

obtaining a gamma value for the imaging environment, based on the calculated gamma value where the V₂ similar to the V₁ is obtained.

(7) An image obtaining apparatus, comprising:

a light source configured to irradiate a biological sample having a fluorescent label with an excitation light, the excitation light exciting the fluorescent label;

an optical system including an objective lens, the objective lens being configured to magnify an imaging target of the biological sample;

an image sensor configured to form an image of the imaging target magnified by the objective lens;

a movement controller configured to move a focus position of the optical system;

a light-exposure controller configured to expose the image sensor to light while moving the focus position of the optical system in an optical-axis direction and in a direction orthogonal to the optical-axis direction;

a calculation unit configured to calculate a gamma value for an imaging environment based on a brightness distribution of one bright-point image in a real-shot-image obtained by the image sensor; and

a correction unit configured to correct an electric signal output from the image sensor by using the gamma value for the imaging environment, the gamma value being calculated by the calculation unit.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of analyzing a linearity of a shot image, comprising:
irradiating a biological sample having a fluorescent label with an excitation light, the excitation light exciting the fluorescent label, and exposing an image sensor to light while moving a focus position of an optical system including an objective lens in an optical-axis direction and in a direction orthogonal to the optical-axis direction; and
analyzing a gamma value for an imaging environment based on a brightness distribution of one bright-point image in a real-shot-image obtained by the image sensor.

2. The method of analyzing a linearity of a shot image according to claim 1, wherein
analyzing a gamma value for the imaging environment includes
comparing a brightness distribution of the real-shot-image with brightness distributions of theoretical bright-point images, the brightness distributions of theoretical bright-point images being obtained by calculation, where a gamma is a variable, under an imaging condition in which an imaging environment of the real-shot-image is simulated except for the image sensor, and
analyzing a gamma value for the imaging environment based on a calculated gamma value of a theoretical bright-point image, the theoretical bright-point image having a brightness distribution similar to a brightness distribution of the real-shot-image.

3. The method of analyzing a linearity of a shot image according to claim 2, wherein
analyzing a gamma value for the imaging environment includes
obtaining an evaluation value V₁ (Value₁) of the shot image by using an expression V₁=(A₁+B₁)/2C₁, where
C₁ is indicative of a brightness at a position exhibiting the highest brightness in the one bright-point image, and
A₁ and B₁ are indicative of brightness at two points in the one bright-point image, each of the two points being a point obtained by rotating the position by 90°, the position exhibiting the highest brightness in the one bright-point image, the center of the one bright-point image being a rotation center, the two points facing each other via the center of the one bright-point image,
obtaining evaluation values V₂ (Value₂) of the theoretical bright-point images by using an expression V₂=(A₂+B₂)/2C₂, where
a gamma is a variable,
C₂ is indicative of a brightness at a position exhibiting the highest brightness in the theoretical bright-point image, and
A₂ and B₂ are indicative of brightness at two points in the theoretical bright-point image, each of the two points being a point obtained by rotating the position by 90°, the position exhibiting the highest brightness in the theoretical bright-point image, the center of the theoretical bright-point image being a rotation center, the two points facing each other via the center of the theoretical bright-point image,
comparing the evaluation value V₁ of the shot image with the evaluation values V₂ of the theoretical bright-point images, and
analyzing a gamma value for the imaging environment, based on the calculated gamma value where the V₂ similar to the V₁ is obtained.

4. An image obtaining method, comprising:
irradiating a biological sample having a fluorescent label with an excitation light, the excitation light exciting the fluorescent label, and exposing an image sensor to light while moving the focus position of an optical system including an objective lens in an optical-axis direction and in a direction orthogonal to the optical-axis direction;
obtaining a gamma value for an imaging environment based on a brightness distribution of one bright-point image in a real-shot-image obtained by the image sensor; and
correcting an electric signal output from the image sensor by using the obtained gamma value to thereby generate a shot image.

5. An image obtaining apparatus, comprising:
a light source configured to irradiate a biological sample having a fluorescent label with an excitation light, the excitation light exciting the fluorescent label;
an optical system including an objective lens, the objective lens being configured to magnify an imaging target of the biological sample;
an image sensor configured to form an image of the imaging target magnified by the objective lens;
a movement controller configured to move a focus position of the optical system;
a light-exposure controller configured to expose the image sensor to light while moving the focus position of the optical system in an optical-axis direction and in a direction orthogonal to the optical-axis direction;
a calculation unit configured to calculate a gamma value for an imaging environment based on a brightness distribution of one bright-point image in a real-shot-image obtained by the image sensor; and
a correction unit configured to correct an electric signal output from the image sensor by using the gamma value for the imaging environment, the gamma value being calculated by the calculation unit.
